(19) United States
(12) Patent Application Publication
(10) Pub. No.: US 2019/0236547 A1
(43) Pub. Date: Aug. 1, 2019

(54) RECORD AND PLAYBACK FOR ONLINE COLLABORATION SESSIONS

(71) Applicant: MOXTRA, INC., LOS GATOS, CA (US)

(72) Inventors: HE HUANG, San Jose, CA (US); Subrah S. Iyar, Los Gatos, CA (US)

(21) Appl. No.: 15/886,713

(22) Filed: Feb. 1, 2018

(51) Int. Cl. G06Q 10/10; H04L 29/06; G06F 17/24; G06F 17/30

(52) U.S. Cl. CPC G06Q 10/101; G06Q 10/103; H04N 21/4788; G06F 17/241; G06F 17/3012; H04L 65/403

(57) ABSTRACT

Technology is disclosed for an online collaboration service that provides for online collaboration sessions, and the recording and playback of those online sessions (the “technology”). The technology enables two or more users to communicate in real-time by sharing streaming data, such as audio or video streams. The technology enables those users to take collaborative actions, such as posting messages, sharing files, sharing screens, annotating virtual whiteboards and allowing remote control of their devices. Metadata associated with users' collaborative actions are shown during the session in an activity timeline. The technology enables users to record and playback online collaboration sessions and their associated timelines. During playback, users are provided with navigation capabilities for both the streaming data and its associated activity timeline, individually and in conjunction.

### FIELD OF THE DISCLOSURE

The disclosure relates to electronic communications and collaboration, and more specifically to the recording and subsequent playback of online collaboration sessions.

### BACKGROUND

Online collaboration sessions are an integration of real-time communication, such as teleconferencing, videoconferencing, web conferencing and messaging, with collaboration tools, such as file sharing, screen sharing, remote device control and whiteboarding. Current collaboration services provide various services, such as the ones described above, for users to collaborate. However, current services lack the ability to record and playback the full collaborative experience. Current technology, such as Cisco System, Inc.'s WebEx® videoconferencing, LogMeIn, Inc.'s GoToMeeting® online meetings, Zoom Video Communications, Inc.'s video and web conferencing and Microsoft Corporation's Skype® for Business videoconferencing, only offers limited recording of audio, video and screen sharing.

Recording a collaboration session's activities, such as participants joining and leaving sessions; presenters beginning or ending a screen share; starting, or participation in, whiteboarding; enabling remote device control; messages posted; and sharing, collaborating upon, documents, allows for the context in which these activities were performed to be accessible and auditable after the fact. Playing back a collaboration session, which further provides the knowledge of who shared their screen, posted a specific message, sent a relevant link, uploaded certain documents, invited other participants, or left the meeting, and of when those collaborative actions took place, imparts a much deeper understanding of the interactions that occurred in the session. The collaborative actions taken, who took those actions and the timing of them—for example—while a presenter was speaking, are valuable information. This information conveys important context that is necessary to fully appreciate the exchange of information and the collaboration that took place.

What is needed therefore is the recording and playback of the full collaborative experience in an online collaboration session.

### SUMMARY

Technology is disclosed for an online collaboration service that provides for online collaboration sessions, and the recording and playback of those online sessions (the “technology”). The technology enables two or more users to communicate in real-time by sharing streaming data, such as audio or video streams. The technology enables those users to take collaborative actions, such as posting messages, sharing files, sharing screens, annotating virtual whiteboards and allowing remote control of their devices. Metadata associated with users' collaborative actions are shown during the session in an activity timeline. The technology enables users to record and playback online collaboration sessions and their associated timelines. During playback, users are provided with navigation capabilities for both the streaming data and its associated activity timeline, individually and in conjunction.

In various embodiments, the technology provides a collaboration session service that can be used with a plurality of users in real-time. For example, in one embodiment, consider that five of six users participated in an online collaboration session: one user-host and four participant-users. One invited-user was unable to join the session. Four of five users were connected to the session by video streamed from their video-enabled desktops, laptops and/or smart phones. One user was connected by audio streamed from a telephone. During the session, the speaking users' video or audio data streams were delivered to the other participants. As the streaming data was delivered, users took various collaborative actions. Users joined the session. A user left the session. Users typed messages and shared them with the other participants. A user shared his smartphone's screen and demonstrated an application. Another user shared and discussed a project's spreadsheet. All of these collaborative actions were displayed to the other participants on their respective devices. Metadata associated with these collaborative actions, such as action type, user and timestamp, was also displayed in real-time in an activity timeline. The activity timeline was presented in a vertical sidebar running alongside the session's video/audio stream.

In various embodiments, the technology provides a session record service that can be used to record online collaboration sessions, and a session playback service that allows users to playback a recorded online collaboration session. Consider again the above example of one embodiment, the user-host requested that the online collaboration session be recorded. Subsequently, the invited-user, who was unable to join, selected the recorded meeting file for playback. The user was presented with the streaming data in a player window and with the activity timeline in a vertical sidebar along the right side of the player window. In this way, the user experienced the meeting as if she was a participant. The user played, paused, fast-forwarded and reversed the streaming data, as needed, to take notes or skip unnecessary information. The user was particularly interested in the discussion of project status and the project spreadsheet. She scrolled down the activity timeline to find the metadata associated with the shared file. She clicked on that point in the timeline, which brought both the streaming data and the activity timeline to that point in time. The user then clicked play and fully experienced the portion of the meeting that was most critical to her. In that way, users are given a comprehensive way to collaborate before, during, and after an online collaborative session.

### BRIEF DESCRIPTION OF THE DRAWINGS

The drawings described herein are for illustrative purposes only of selected embodiments and not all possible implementations and are not intended to limit the scope of the present disclosure.

FIG. 1 is a block diagram illustrating an environment in which the technology may operate in various embodiments.

FIG. 2 is a block diagram illustrating an environment for providing a collaboration session service, a session record service and a session playback service, consistent with various embodiments.

FIG. 3 is a series of exemplar screen shots from a device of a user of FIG. 2, which show a collaboration session in progress, and a recorded collaboration session in a player, consistent with various embodiments.

FIG. 4 is an exemplar screen shot from a device of a user of FIG. 2, which show a recorded activity timeline in a player, consistent with various embodiments.

FIG. 5 is a block diagram of a system for an online collaboration service of FIG. 1, consistent with various embodiments.

FIG. 6 is a flow diagram of a process of conducting a collaboration session, consistent with various embodiments.

FIG. 7 is a flow diagram of a process of recording a collaboration session, consistent with various embodiments.

FIG. 8A is a flow diagram of a process of playing a recorded collaboration session, consistent with various embodiments.

FIG. 8B is a flow diagram of a process of conducting user navigation of a recorded collaboration session, consistent with various embodiments.

FIG. 9 is a block diagram illustrating components of an apparatus that may perform various operations described by the technology.

### DEFINITIONS

Activity Bar: an indicator that indicates how much collaborative user activity occurred during the course of a recorded online collaboration session.

Activity Metadata: data that describes and provides information about collaborative user actions taken during an online collaboration session.

Activity Timeline: a presentation of activity metadata that describes and summarizes collaborative user actions. Activity timelines may be present activity metadata in chronological order in a vertical sidebar alongside the streaming data of an online collaboration session.

Collaborative User Action: an action taken by a user who is participating in an online collaboration session. Collaborative user actions may include actions relating to starting, ending or joining a collaboration session; inviting users to a session; posting messages; sharing screens; sharing files; whiteboarding; or remotely controlling devices.

Current Playback Time: a parameter that represents the point in time in the recorded session video file that is currently being played back. Current Playback Time may be synchronized with the video time as the video plays, and as users pause, fast forward, reverse or reposition the video.

Current Timeline Time: a parameter that represents the point in time in the recorded activity timeline that is currently being presented. Current Timeline Time may be synchronized with the presentation of the recorded activity timeline as users take related user navigational actions; or Current Playback Time.

JavaScript Object Notation (JSON): an open-standard file format that uses human-readable text to transmit data objects consisting of attribute-value pairs and array data types.

Media Player: a computer program for playing multimedia files like videos. Media players commonly display standard media control icons, such as play, pause, fast forward, back, forward and stop buttons, and a progress bar.

Moving Picture Experts Group (MPEG) is a set of international standards and file formats for encoding and compressing video images.

MPEG-4 Part 14 (MP4): a digital multimedia container format most commonly used to store video and audio but can also be used to store other data such as subtitles and still images.

Navigational User Action: an action taken by a user who is playing back a recorded online collaboration session. Navigational user actions may include actions relating to playing back of the recorded session video file, such as selecting a media control icon, a position on a progress bar, a position on an activity bar or a position on a recorded activity timeline; or actions relating to presenting a recorded activity timeline, such as moving a scrollbar or selecting a timeline control icon, such as a back-to-current icon.

Online Collaboration Session: a joint session of users where collaborative actions of each participating user, as seen on the screen of a device of a presenter, are mirrored on the screens of the devices of the other participating users in real-time. Online collaboration sessions may also include an activity timeline describing the collaborative user actions.

Playback: a service allowing users to playback a recorded online collaboration session, including the streaming data and the activity timeline.

Playback Navigation: a service allowing users to navigate both the playing back of a recorded session video file, and the presentation of a recorded activity timeline, separately and in conjunction.

Playback Session: a session where a user plays back a recorded online collaboration session.

Progress Bar: an indicator in media players that indicates how much of the video has been played.

Recorded Activity Timeline: an activity timeline, which may be recreated by chronologically ordering the activity metadata, that represents the activity timeline as presented during a recorded online collaboration session.

Recorded Session Video File: a video file, created by chronologically ordering stored data stream files, that represents the streaming data as presented during a recorded online collaboration session.

Remote Device Control: function that allows a user to connect to a device in another location, see that device's screen and interact with it as if it were local.

Screen Sharing: function that allows people from a variety of locations view another computer screen in real-time.

Scrollbar: is an interaction technique in which continuous text or any other content can be scrolled in a predetermined direction (up, down, left, or right) on a computer display so that all of the content can be viewed, even if only a fraction of the content can be seen on a device's screen at one time.

Streaming Data: streaming data of one participant user that is shared with other participating users in an online collaboration session. Streaming data may be of different types, such as audio, video, computer file, screen sharing, remote device control and whiteboarding data.

Streaming Metadata: data that describes the different user streaming data shared in an online collaboration session.

Timeline Control Icon: an icon that, when selected, effects the presentation of a recorded activity timeline. For example, Back-To-Current Icon is displayed when the activity timeline is scrolled past the Current Playback Time. Selecting that icon navigates the timeline back to the Current Playback Time.

Timestamp: a record of the time a certain event occurred, or a certain collaborative user action occurred.

Video encoding: function that converts digital video files from one format to another format.

Whiteboarding: the placement of shared, virtual whiteboards in an online collaboration session whereby users may annotate shared files, type text, draw figures and insert images in real time with other users in the session.

### DETAILED DESCRIPTION

### Environment for Online Collaboration Service

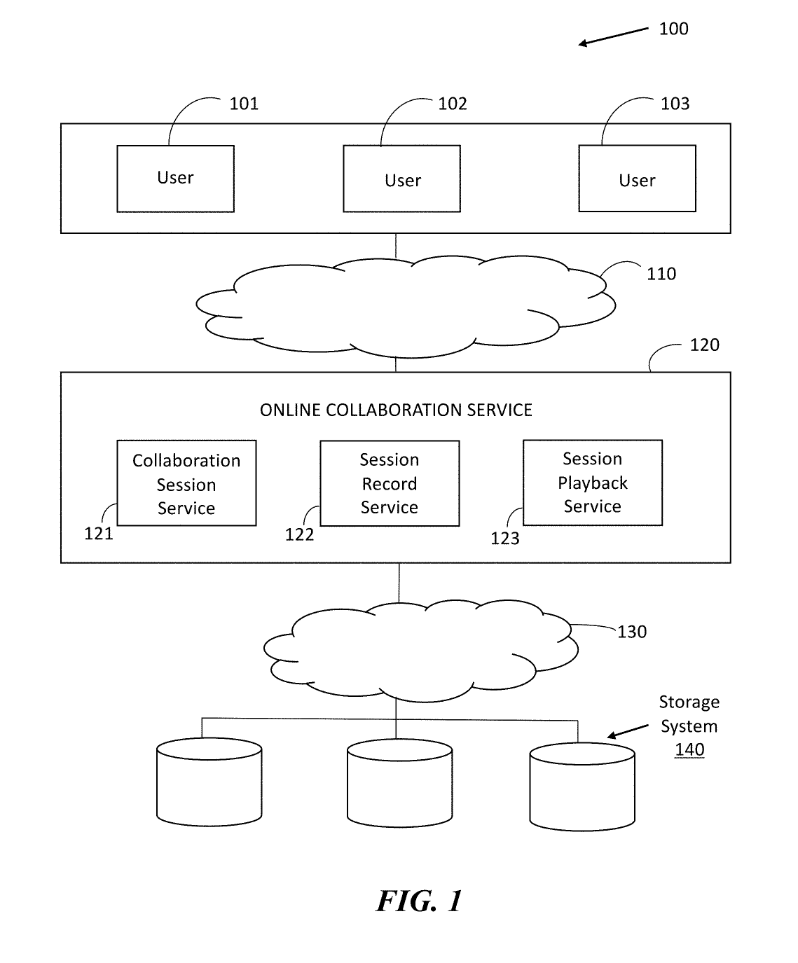

Technology is disclosed for an online collaboration service that provides for online collaboration sessions, and the recording and playback of those online sessions (the “technology”). Several embodiments of the technology are described in more detail in reference to the figures. Turning to FIG. 1, FIG. 1 is a block diagram illustrating an environment 100 in which the technology may operate in various embodiments. The environment 100 includes an online collaboration service 120 that provides a set of services, including services such as a collaboration session service 121, a session record service 122 and a session playback service 123 to a set of users, e.g., user 101, user 102 and user 103. The set of users may access the online collaboration service 120 via a communication network 110 using a variety of devices, including a desktop, a laptop, a tablet PC, a smart phone, or a telephone.

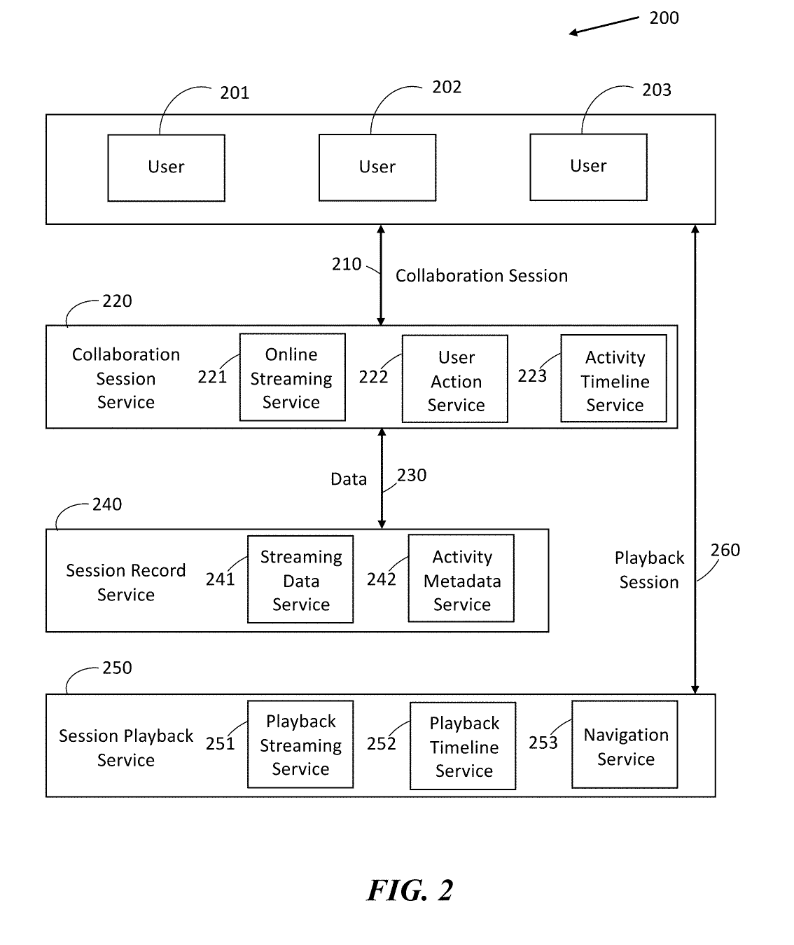

In various embodiments, online collaboration service 120 provides for the participation in, and the recording and playback of, online collaboration sessions for a set of users, such as users 101, 102 and 103. The collaboration session service 121 allows users to start, join or invite others to join online collaboration sessions, which are joint session of users where collaborative actions of each participating user as seen on the screen of a device of a presenter (e.g., generating audio/video streaming data, sharing files or annotating shared documents) are mirrored on the screens of the devices of the other participating users in real-time. The session record service 122 allows users to record an online collaboration session, including streaming data and metadata that describes the streaming data and collaborative user actions. The session playback service 123 allows users to playback the recorded online collaboration sessions, consistent with various embodiments. Further details regarding participating in, and the recording and playing back of, online collaboration sessions are described with reference to at least FIGS. 2 and 5-10.

Online collaboration service 120 may be implemented in a variety of configurations. One typical configuration may include an online configuration in which online collaboration service 120 is implemented in a distributed network, for example, LAN, WAN or Internet. Users access online collaboration service 120 over a communication network such as network 110. In various embodiments, online collaboration service 120 may also be implemented in a client-server configuration in which an application corresponding to the client portion may be installed on the device of the user. Users may access online collaboration service 120 using a web browser or an online collaboration service application installed on the device of the user.

### Online Collaboration Service

Turning now to FIG. 2, FIG. 2 is a block diagram, consistent with various embodiments, illustrating an environment 200 for the online collaboration service of FIG. 1. Collaboration session service 220 of environment 200 may be similar to collaboration session service 121 of FIG. 1. Session record service 240 of environment 200 may be similar to session record service 122 of FIG. 1. Session playback service 250 of environment 200 may be similar to session playback service 123 of FIG. 1. Users 201, 202 and 203 of environment 200 may be similar to users 101, 102 and 103 of FIG. 1.

### Collaboration Session Service

Collaboration session service 220, consistent with various embodiments, establishes an online collaboration session, such as collaboration session 210, between a plurality of users, such as users 201, 202 and 203. Users may start or join online collaboration sessions. Online streaming service 221 allows users to share streaming data, consistent with various embodiments. For example, users may stream audio from telephonic devices, video from video-enabled devices, computer file data, whiteboarding data, screen data and remote device control data, all in real-time.

Online streaming service 221 provides for the receipt and distribution of the various streaming data, consistent with various environments. For example, one user may be the first presenter in a collaboration session, such as from the start of the session (e.g., at 00:00:00) to past nine minutes (e.g., at 09:17:05) into the session. This first presenter's video stream may be received, selected, placed in the shared session and distributed to the participating users. A second presenter may share her device's screen while demonstrating an application or app from, e.g., 09:17:06 to 21:54:33 in session time. This second presenter's screen data stream may be received, selected, placed in the shared session and distributed to the participating users. In this way, users participate in online collaboration sessions by presenting and receiving streaming data.

User action service 222, allows users, such as users 201, 202 and 203, in an online collaboration session, such as collaboration session 210, to perform a variety of collaborative actions. For example, consistent with various embodiments, users may do one or more of the following collaborative actions: start or end a session; join or leave a session; invite another user to join a session; post a message in a session, start or end sharing their device's screen within a session, start or end sharing a file on their device within a session; start, end, or participate in, whiteboarding within a session; start, end, or give access to, remote device control within a session; and start or end recording a session.

User action service 222 creates activity metadata describing collaborative actions taken by users. For example, consistent with various embodiments, activity metadata associated with collaborative actions may include user information, such as name, user id, email address and phone number; device information, such as hardware type and platform (e.g., smart phone operating system, Internet browser or desktop operating system); timestamps, such as for when a collaborative user action was taken, started and/or ended; and computer file information, such as filenames, sizes and types. In some embodiments, metadata, such as activity metadata, may be stored in JSON (JavaScript Object Notation) files.

Activity timeline service 223 presents, in real-time, activity metadata in an activity timeline that describes collaborative user actions taken by users, such as users 201, 202 and 203, in an online collaboration session, such as collaboration session 210, consistent with various embodiments. In some embodiments, activity timelines may be presented in a vertical sidebar alongside the streaming data of collaboration sessions. At the time a user takes a collaborative action, the associated, new activity metadata would be concatenated below the activity metadata associated with the previous collaborative user action. In that way, older activity metadata scrolls up, and eventually off, the vertical sidebar. For example, a presenting user's video stream might be displayed in an online collaboration session. While the presenter is speaking, a user joins the session a few seconds after another user posted a message. As a result, in the activity timeline sidebar alongside the presenter's video stream, the activity metadata “Mina Smith joined the meeting—2:37 pm” is concatenated below the activity metadata “Peter Nemo—2:37 pm—OK”.

### Session Record Service

Turning back to FIG. 2, session record service 240, consistent with various embodiments, allows users, such as users 201, 202 and 203, to record online collaboration sessions, such as collaboration session 210. Session record service 240 receives data 230 associated with collaboration session 210 from online collaboration service 220. Data 230 includes streaming data, streaming metadata and activity metadata. Streaming data may be of different types, such as audio, video, computer file, screen sharing, remote device control and whiteboarding data. Streaming data may include multiple data streams from one or more users. For example, consistent with various embodiments, one user may be the first presenter in a collaboration session, such as from 00:00:00 to 09:17:05 into the session. This first presenter's streaming data would be a video data stream and would be one of a plurality data streams associated with the session. A second presenter may share her device's screen while demonstrating an application or app from, e.g., 09:17:06 to 21:54:33 in session time. This second presenter's streaming data would be a screen data stream and would be another of a plurality of data streams associated with the session.

The streaming metadata, included in data 230, describes the collaboration session's different data streams. For example, consistent with various embodiments, streaming metadata associated with an audio stream may include user name, audio format, presentation start time, presentation end time and source filename. Metadata associated with a video stream may include user name, video format, presentation start time, presentation end time and source filename. As discussed above, activity metadata describes the collaborative actions taken by users. In some embodiments, metadata, such as streaming and activity metadata, may be stored in JSON (JavaScript Object Notation) files.

Streaming data service 241 creates (when recording starts), saves to, and stores the final versions of (when recording ends), the files for a collaboration session's different data streams, consistent with various embodiments. Streaming data service 241 creates (when recording starts), saves to, and stores the final versions of (when recording ends), the file for a collaboration session's streaming metadata. Activity metadata service 242 creates (when recording starts), saves to, and stores the final versions of (when recording ends), the file for a collaboration session's activity metadata.

Session record service 240, when recording ends, creates a recorded session video file that represents the streaming data as presented during the recorded online collaboration session, consistent with various embodiments. Session record service 240 processes the session's streaming data files, using the streaming metadata to chronologically order them in the recorded session video file. In some embodiments, video encoding is used to convert the different streaming data to the same standard format, such as an MPEG (Moving Picture Experts Group) format. For example, consistent with various embodiments, a first presenter's video data stream might be stored in a video stream file and its associated metadata might show a presentation start time of 00:00:00 and a presentation end time of 09:17:05. A second presenter's screen data stream might be stored in a screen data stream file and its associated metadata might show a presentation start time of 09:17:06 and a presentation end time of 21:54:33. Session record service 240 would place the video stream file first in the recorded session video file, followed by the screen data stream file. In this way, the recorded session video file contains the session's data streams in the chronological order that they were presented to users.

### Session Playback Service

Turning back to FIG. 2, session playback service 250, consistent with various embodiments, allows users, such as users 201, 202 and 203, to playback recorded online collaboration sessions, such as collaboration session 210. Playback streaming service 251 allows users to playback the recorded session video file. In some embodiments, media player software may be used. Playback streaming service 251 initializes and maintains a value for the parameter, Current Playback Time, which represents the point in time in the video that is currently being played. Current Playback Time is synchronized with the recorded session video time as the video is played, and as the user pauses, fast forwards, reverses or repositions the video.

Playback timeline service 252, recreates the recorded activity timeline associated with a recorded online collaboration session, such as collaboration session 210, consistent with various environments. Playback timeline service 252 processes the stored activity metadata file, using the metadata associated with the recorded session to chronologically order the activities in a recorded activity timeline, as those activities were displayed during the session. For example, the activity metadata may show that a user (Peter Nemo) took an action (post message) with text (‘OK’) at a particular time (15:37:03). The metadata may also show that, a few seconds later, a user (Mina Smith) took an action (join session) at a particular time (15:37:42). Playback timeline service 252 would place in the recorded activity timeline the activity metadata “Mina Smith joined the meeting—2:37 pm” below the activity metadata “Peter Nemo—2:37 pm—OK”. In this way, the recorded activity timeline contains the activity metadata in the chronological order that the activities were first presented to users.

Playback timeline service 252 presents the recorded activity timeline associated with a recorded online collaboration session, such as collaboration session 210, consistent with various environments. In some embodiments, recorded activity timelines may be presented in a vertical sidebar alongside the playback of the recorded session video file. Playback timeline service 252 initializes and maintains a value for the parameter, Current Timeline Time, which represents the point in time in the timeline that is currently being presented. Playback timeline service 252 synchronizes Current Timeline Time with both the activity timeline as the user scrolls (moves the timeline) forward or backward in time; and with Current Playback Time as the user plays, pauses, fast forwards, reverses or repositions the recorded session video file. Older activity metadata scrolls up, and eventually off, the vertical sidebar as Current Timeline Time, synchronized with Current Playback Time, increases. In that way, the recorded activity timeline is presented in playback as the original, activity timeline was presented in real-time.

Playback timeline service 252, creates and displays an activity bar associated with a recorded online collaboration session, such as collaboration session 210, consistent with various environments. Playback timeline service 252 processes the stored activity metadata file, using the metadata associated with the recorded session to determine the level of activity that occurred chronologically over the session's time period. In some embodiments, the activity bar may mirror the media player's progress bar. For example, if collaborative user actions occurred from 00:01:00 to 00:14:33, that portion of the activity bar may be displayed as orange. If no collaborative user actions occurred from 00:27:49 to 00:51:06, that portion of the activity bar may be displayed as black.

Navigation service 253 allows users, such as users 201, 202 and 203, to navigate the playback of a recorded session video file. Users may take navigational actions that result in a change to the value for Current Playback Time, which would result in a change in the point in time being played in the video. Users may take one or more of the following navigational actions: select a media control icon, such as a play, pause, forward, fast forward, back or stop button; select a position on a progress bar; select a position on an activity bar; or select a position on a recorded activity timeline associated with a collaborative user action. Selecting a media control icon may change the value of Current Playback Time. Selecting a position on the progress bar may change the value of Current Playback Time to be equal to the selected time on the progress bar. Selecting a position on the activity bar may change the value of Current Playback Time to be equal to the selected time on the activity bar. Selecting a position associated with an activity on the recorded activity timeline may change the value of Current Playback Time to be equal to the activity's timestamp. Changing the value of Current Playback Time may change the value of Current Timeline Time. In that way, the recorded activity timeline is presented in synchronicity with Current Playback Time.

Navigation service 253 allows users, such as users 201, 202 and 203, to navigate the presentation of the recorded activity timeline. Users may take navigational actions that result in a change to the value for Current Timeline Time, which would result in a change to the point in time being presented in the recorded activity timeline. Users may take one or more of the following navigational actions: move the position of a scrollbar; or select a timeline control icon, such as back-to-current icon. Moving the position of the scrollbar may increase or decrease Current Timeline Time, which would cause activity metadata to scroll up or down (and on or off) the displayed timeline. When the activity timeline is scrolled past the Current Playback Time, a back-to-current icon is displayed. Selecting the back-to-current icon changes the value of Current Timeline Time to be equal to Current Playback Time. In that way, the recorded activity timeline is presented in response to navigational user actions.

Collaboration session service, such as collaboration session service 220, session record service, such as session record service 240, and session playback service, such as session playback service 250, may be accessed using a variety of devices, including a desktop computer, a laptop computer, a smartphone, or a tablet PC. They may also be accessed using a web browser installed on user devices. Further, the online collaboration service environment 200 is platform agnostic, that is, users may join, record or playback online collaboration sessions, such as online collaboration session 210, from devices running on operating systems, such as Microsoft Corporation's Windows, Apple Inc.'s macOS® and iOS®, Google Inc.'s Chrome OS™ operating systems, and various implementations of the Android OS operating system.

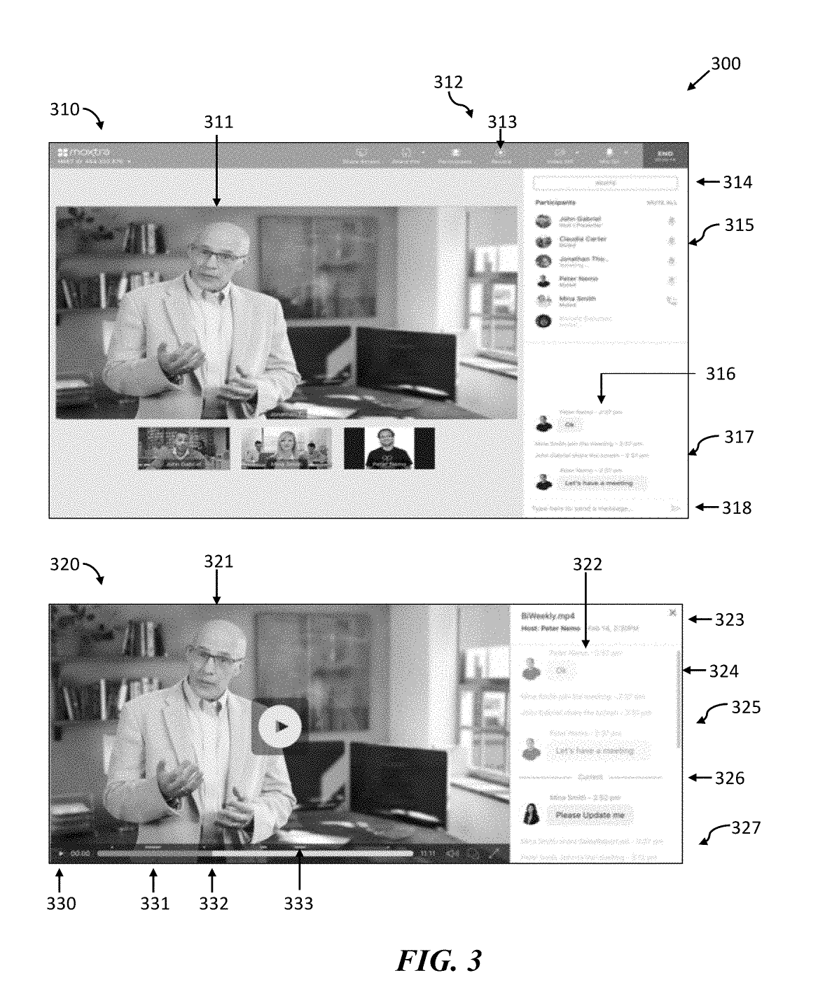

Turning now to FIG. 3, FIG. 3 is two exemplar screen shots 300 from a device of a user of FIG. 2, consistent with various embodiments. Screen shot 310 shows an online collaboration session occurring. A currently-presenting user's video stream 311 is being shared with the other participating users in the session. A list of the current participating users 315 is displayed above the activity timeline 316. Users may take collaborative actions by selecting icons 312 displayed across the top of the screen, such as icons associated with share screen, share file, share video stream, share audio stream or end session. Users may record the session by selecting a record icon 313, invite another user by selecting an invite icon 314, or post messages by entering text and selecting the post icon 318. As users take collaborative actions, the associated activity metadata is presented in chronological order in the activity timeline 317.

Screen shot 320 shows a recorded online collaboration session being played back, consistent with various embodiments. A user is playing the recorded session video file 323 in a media player 321. Current Playback Time is indicated by a point 332 on the progress bar 331 and a marker 326 on the recorded activity timeline 322. The user may navigate playback by selecting a media control icon 330, selecting a position on the progress bar 332, selecting a position on the activity bar 333, or selecting one of the presented activities 325, 327 in the recorded activity timeline 322. Activities 325 presented above the marker 326 occurred before Current Playback Time. Activities 325 presented below the marker 326 occurred after Current Playback Time, consistent with various environments. The user may navigate presentation of the recorded activity timeline 322 by moving the position of the scrollbar 324.

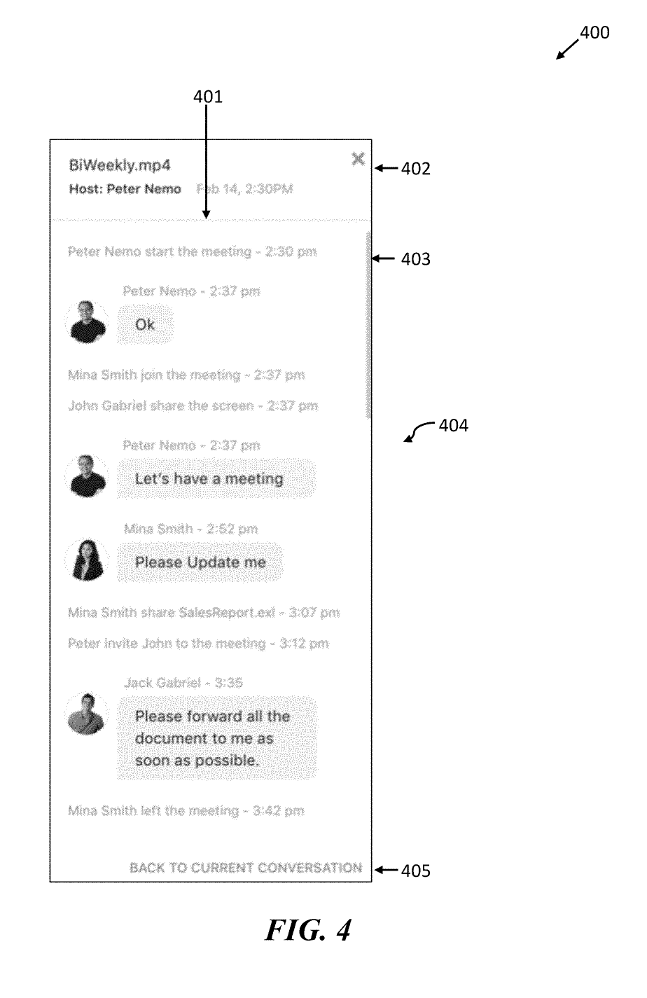

Turning now to FIG. 4, FIG. 4 is an exemplar portion of a screen shot 400 from a device of a user of FIG. 2, consistent with various embodiments. A user is playing the recorded session video file 402 and navigating the recorded activity timeline 401. The user is moving scrollbar 403 to view the activity metadata 404 associated with collaborative user actions 404 taken during the recorded online collaboration session. When the user scrolled past the marker 326 of FIG. 3, which indicates the Current Playback Time, a back-to-current icon 405 is presented to the user. The user will navigate back to the marker 326 of FIG. 3, if the user selects the back-to-current icon 405, consistent with various environments.

### Example System for Online Collaboration Service

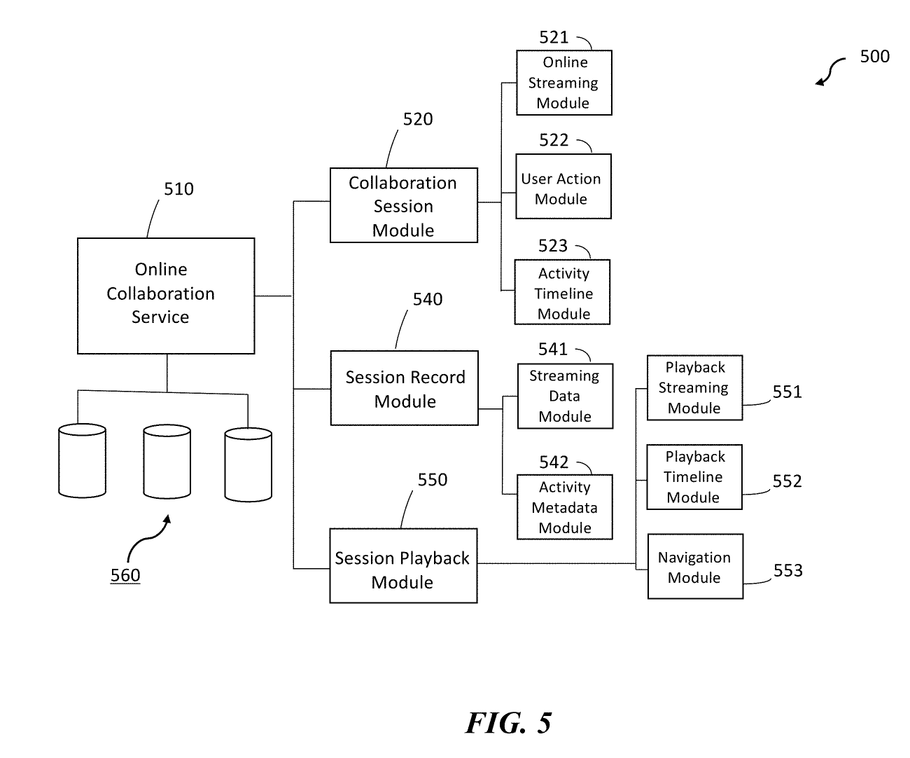

Turning now to FIG. 5, FIG. 5 is a block diagram of a system for an online collaboration service of FIG. 1, consistent with various embodiments.

In various embodiments, system 500 is implemented to perform functions such as the functions of environment 100. In various embodiments, online collaboration service 510 may be similar to the online collaboration service 120 of FIG. 1. Online collaboration service 510 includes various modules that provide services including collaboration session services, session record services and session playback services.

Online collaboration service 510 includes collaboration session module 520, session record module 540 and session playback module 550. In various embodiments, collaboration session module 520 may be similar to collaboration session service 121 of FIG. 1. Collaboration session module 520 includes modules to conduct online collaboration sessions. These modules may be similar to the collaboration session services of FIG. 2. Online streaming module 521 may be similar to online streaming service 221 of FIG. 2. Online streaming module 521 facilitates the receipt and distribution of streaming data within a collaboration session. User action module 522 may be similar to user action service 222 of FIG. 2. User action module 522 facilitates the user to take collaborative actions within a collaboration session. Activity timeline module 523 may be similar to activity timeline service 223 of FIG. 2. Activity timeline module 523 facilitates the presentation of an activity timeline that describes user collaborative actions.

In various embodiments, session record module 540 may be similar to session record service 122 of FIG. 1. Session record module 540 includes modules to record online collaboration sessions. These modules may be similar to the session record services of FIG. 2. Streaming data module 541 may be similar to streaming data service 241 of FIG. 2. Streaming data module 541 facilitates the creation, saving to, and storing, of streaming data files and a streaming metadata file for a collaboration session's different data streams. Activity metadata module 542 may be similar to activity metadata service 242 of FIG. 2. Activity metadata module 542 facilitates the creation, saving to, and storing, of an activity metadata file for collaborative user actions.

In various embodiments, session playback module 550 may be similar to session playback service 123 of FIG. 1. Session playback module 550 includes modules to playback recorded online collaboration sessions. These modules may be similar to the session playback services of FIG. 2. Playback streaming module 551 may be similar to playback streaming service 251 of FIG. 2. Playback streaming module 551 facilitates the user to playback recorded session video files. Playback timeline module 552 may be similar to playback timeline service 252 of FIG. 2. Playback timeline module 552 facilitates the recreation of the recorded activity timeline associated with the recorded session video file, the presentation of the recorded activity timeline, and the creation and display of an activity bar. Navigation module 553 may be similar to navigation service 253 of FIG. 2. Navigation module 553 facilitates the user to take navigational actions with respect to the playback of recorded session video files and to the presentation of recorded activity timelines.

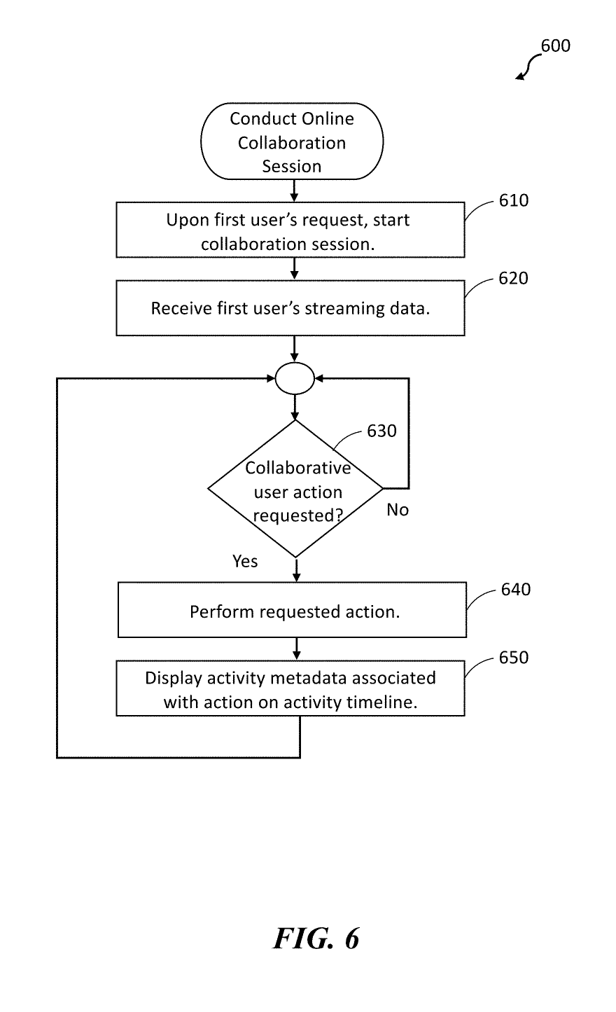

Turning now to FIG. 6, FIG. 6 is a flow diagram of a process of conducting an online collaboration session, consistent with various embodiments.

In some embodiments, process 600 may be executed in a system such as system 500 of FIG. 5. At block 610, collaboration session module 520 receives a request from a first user to start a collaboration session. At block 620, online streaming module 521 receives the first user's streaming data. At block 630, user action module 522 determines whether a user has requested a collaborative action. If not, user action module 522 repeats the determination as to whether a user has requested a collaborative action. If so, at block 640, user action module 522 performs the requested action. At block 650, activity timeline module displays the activity metadata associated with the performed action on the activity timeline.

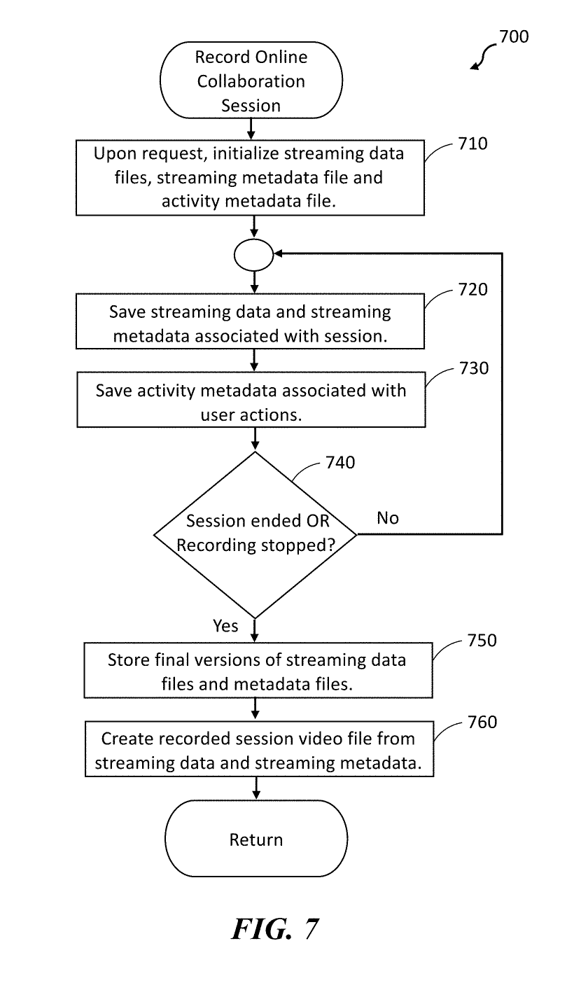

Turning now to FIG. 7, FIG. 7 is a flow diagram of a process of recording an online collaboration session, consistent with various embodiments.

In some embodiments, process 700 may be executed in a system such as system 500 of FIG. 5. At block 710, upon a request to record, session record module 540 initializes files for streaming data, streaming metadata and activity metadata. At block 720, streaming data module 541 saves streaming data and streaming metadata associated with the online collaboration session. At block 730, activity data module 542 saves activity metadata associated with collaborative user actions taken during the collaboration session. At block 740, session record module 540 determines whether the collaboration session ended, or the recording stopped. If not, process 700 repeats beginning at block 720. If so, at block 750, streaming data module 541 and activity data module 542 store the final versions of their respective streaming data files and metadata files; and, at block 760, session record module 540 creates a recorded session video file from the processing of the streaming data files and streaming metadata file.

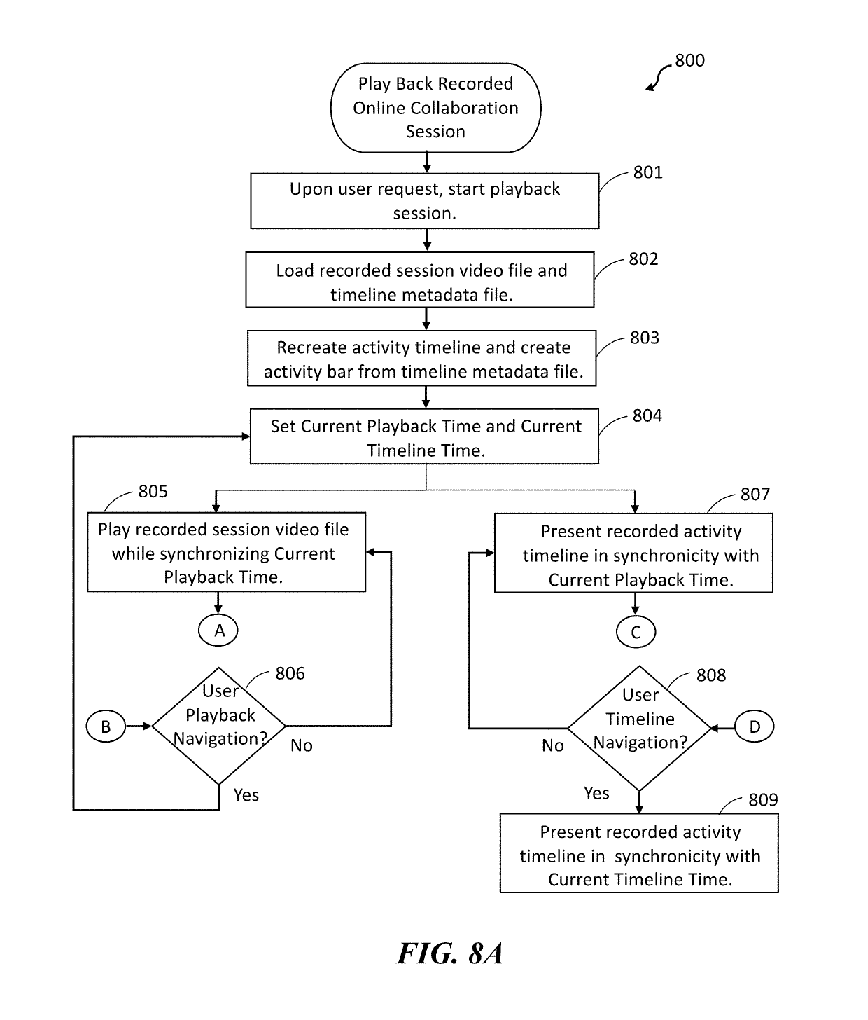

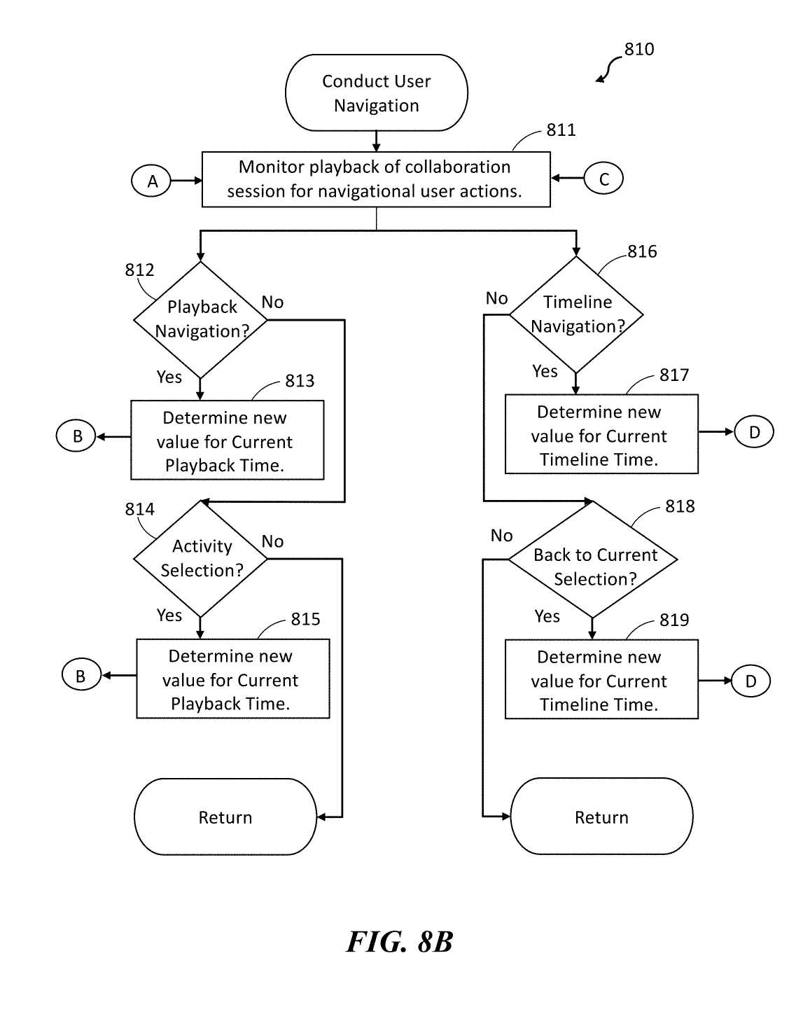

Turning now to FIG. 8A, FIG. 8A is a flow diagram of a process of playing back a recorded online collaboration session, consistent with various embodiments.

In some embodiments, process 800 may be executed in a system such as system 500 of FIG. 5. At block 801, session playback module 550 starts a playback session. At block 802, session playback module 550 loads the recorded session video file and the stored activity metadata file, both associated with the recorded online collaboration session. At block 803, playback timeline module 552 recreates the recorded activity timeline and creates the activity bar from the processing of the stored activity metadata file. At block 804, session playback module 550 sets values for the parameters, Current Playback Time and Current Timeline Time.

At block 805, playback streaming module 551 plays the recorded session video file beginning at Current Playback Time and synchronizes Current Playback Time with the video time as the video is being played. Further steps, related to determining whether playback navigation occurred, are illustrated in FIG. 8B, as indicated by the circled letter “A” in FIG. 8A at 805 and FIG. 8B at 811. At block 806, navigation module 553 has determined whether playback navigation occurred. If not, process 800 repeats beginning at block 805. If so, process 800 repeats beginning at block 804.

At block 807, playback timeline module 552 presents the recorded activity timeline beginning at Current Timeline Time and synchronizes Current Timeline Time with Current Playback Time as the recorded session video file is being played. Further steps, related to determining whether timeline navigation occurred, are illustrated in FIG. 8B, as indicated by the circled letter “C” in FIG. 8A at 807 and FIG. 8B at 811. At block 808, navigation module 553 has determined whether timeline navigation occurred. If not, process 800 repeats beginning block 807. If so, at block 809, playback timeline module 552 presents the recorded activity timeline beginning at Current Timeline Time and synchronizes Current Timeline Time with the activity timeline as the timeline is navigated.

Turning now to FIG. 8B, FIG. 8B is a flow diagram of a process of conducting user navigation, consistent with various embodiments.

In some embodiments, process 810 may be executed in a system such as system 500 of FIG. 5. At block 811, navigation module 553 monitors playback of a recorded online collaboration session for navigational user actions. At block 812, navigation module 553 determines whether playback navigation occurred. That it is to say, whether a user took a navigational action with respect to the playing back of the recorded session video file, such as selecting a media control icon, selecting a position on the progress bar or selecting a position on the activity bar. If so, at block 813, navigation module 553 determines a new value for Current Playback Time. Further steps, related to playing video, are illustrated in FIG. 8A, as indicated by the circled letter “B” in FIG. 8B at 813 and FIG. 8A at 806.

If not, at block 814, navigation module 553 determines whether a user took the navigational action of selecting a position on the recorded activity timeline associated with a collaborative user action. If so, at block 815, navigation module 553 determines a new value for Current Playback Time. Further steps, related to playing video, are illustrated in FIG. 8A, as indicated by the circled letter “B” in FIG. 8B at 815 and FIG. 8A at 806.

At block 816, navigation module 553 determines whether timeline navigation occurred. That it is to say, whether a user took a navigational action with respect to presenting the recorded activity timeline, such as moving a scrollbar. If so, at block 817, navigation module 553 determines a new value for Current Timeline Time. Further steps, related to presenting the timeline, are illustrated in FIG. 8A, as indicated by the circled letter “D” in FIG. 8B at 817 and FIG. 8A at 808. If not, at block 818, navigation module 553 determines whether a user took the navigational action of selecting a timeline control icon, such as the back-to-current icon. If so, at block 819, navigation module 553 determines a new value for Current Timeline Time. Further steps, related to presenting the timeline, are illustrated in FIG. 8A, as indicated by the circled letter “D” in FIG. 8B at 819 and FIG. 8A at 808.

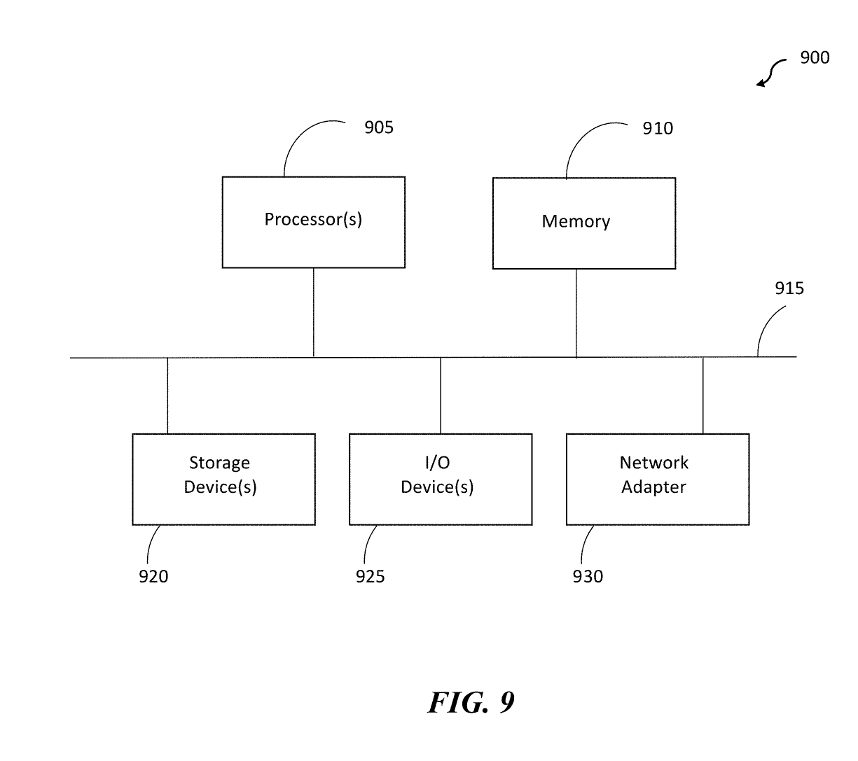

Turning now to FIG. 9, FIG. 9 is a block diagram illustrating components of an apparatus that may perform various operations described by the technology.

FIG. 9 is a block diagram of a computer system as may be used to implement features of some embodiments of the disclosed technology. Computing system 900 may include one or more central processing units (“processors”) 905, memory 910, input/output devices 925 (e.g., key-board and pointing devices, and display devices), storage devices 920 (e.g., disk drives), and network adapters 930 (e.g., network interfaces) that are connected to an interconnect 915. The interconnect 915 is illustrated as an abstraction that represents any one or more separate physical buses, point to point connections, or both connected by appropriate bridges, adapters, or controllers. The interconnect 915, therefore, may include, for example, a system bus, a Peripheral Component Interconnect (PCI) bus or PCI-Express bus, a Hyper Transport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 910 and storage devices 920 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media may include computer-readable media (e.g., “non-transitory” media) and computer-readable transmission media. The instructions stored in memory 910 may be implemented as software and/or firmware to program the processor(s) 905 to carry out actions described above. In some embodiments, such software or firmware may be initially provided to the processing system 900 by downloading it from a remote system through the computing system 900 (e.g., via network adapter 930).

The technology introduced herein may be implemented by, for example, programmable circuitry (e.g., one or more microprocessors) programmed with software and/or firmware, or entirely in special-purpose hardwired (non-program-mable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. Accordingly, the invention is not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure in this specification are used to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing may be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, sub-steps may be performed in parallel, illustrated logic may be omitted, other logic may be included, etc.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Furthermore, in the specification, figures and claims, reference is made to particular features (including method steps) of the invention. It is to be understood that the disclosure of the invention includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C may consist of (i.e., contain only) components A, B and C, or may contain not only components A, B, and C but also contain one or more other components.

Where reference is made herein to a method comprising two or more defined steps, the defined steps may be carried out in any order or simultaneously (except where the context excludes that possibility), and the method may include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” “program,” “device,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. §112 ¶ 6. Specifically, the use of “step of” in the claims herein is not intended to invoke the provisions of U.S.C. § 112 ¶ 6.

We claim:

1. An online collaboration method comprising:
conducting, by an online collaboration service executing on a computer system, an online collaboration session with one or more users;
receiving, by the online collaboration service, streaming data from the one or more users;
distributing, by the online collaboration service, the received streaming data to the one or more users;
performing, by the online collaboration service, one or more collaborative user actions;
presenting, by the online collaboration service, an activity timeline;
recording, by the online collaboration service, the distributed streaming data and the presented activity timeline;
playing back, by the online collaboration service, the recorded streaming data and the recorded activity timeline; and
navigating, by the online collaboration service, the playing back of the recorded streaming data and the recorded activity timeline.

2. The method of claim 1, wherein the collaborative user actions include start session, end session and join session.

3. The method of claim 1, wherein the collaborative user actions include invite user.

4. The method of claim 1, wherein the collaborative user actions include post message.

5. The method of claim 1, wherein the collaborative user actions include start screen share and end screen share.

6. The method of claim 1, wherein the collaborative user actions include start file share and end file share.

7. The method of claim 1, wherein the collaborative user actions include start whiteboarding, participate in whiteboarding and end whiteboarding.

8. The method of claim 1, wherein the collaborative user actions include start remote device control, give access to remote device control and end remote device control.

9. The method of claim 1 wherein conducting an online collaboration session includes:
starting, upon a first user's request, an online collaboration session;
receiving the first user's streaming data;
IF a collaborative user action is requested THEN performing the requested collaborative user action;
displaying activity metadata associated with the requested collaborative user action in an activity timeline;
returning to determining whether a collaborative user action is requested;
ELSE
returning to determining whether a collaborative user action is requested.

10. The method of claim 1 wherein recording an online collaboration session includes:
initializing one or more streaming data files, a streaming metadata file and an activity metadata file;
saving streaming data to the one or more streaming data files, streaming metadata to the streaming metadata file, and activity metadata to the activity metadata file;
IF the online collaboration session ends OR the recording stops THEN storing streaming data to the one or more streaming data files, streaming metadata to the streaming metadata file, and activity metadata to the activity metadata file;
creating a recorded session video file from the one or more stored streaming data files and the stored streaming metadata file;
ELSE
return to saving streaming data, streaming metadata and activity metadata.

11. The method of claim 1 wherein playing back an online collaboration session includes:
starting, upon a user's request, a playback session;
loading a recorded session video file and a stored timeline metadata file;
recreating a recorded activity timeline from the stored timeline metadata file;
creating an activity bar from the stored timeline metadata file;
setting values for Current Playback Time and Current Timeline Time;
playing back the recorded session video file, beginning at Current Playback Time, while synchronizing Current Playback Time with the video time of the recorded session video file;
presenting the recorded activity timeline, beginning at Current Timeline Time, while synchronizing Current Timeline Time with Current Playback Time;
IF a user navigational action has occurred affecting the playback of the recorded session video file THEN
determining a new value for Current Playback Time;
returning to setting values for Current Playback Time and Current Timeline Time;
ELSE IF a user navigational action has occurred affecting the presentation of the recorded activity timeline THEN
determining a new value for Current Timeline Time;
presenting the recorded activity timeline beginning at the new value for Current Timeline Time;
ELSE
returning to playing back the recorded session video file and presenting the recorded activity timeline.

12. The method of claim 1 wherein conducting user navigation includes:
IF a navigational user action is taken THEN
IF the navigational user action is one of selecting a media control icon, selecting a position on a progress bar, selecting a position on an activity bar, or selecting a position on a recorded activity timeline THEN
determining a new value for Current Playback Time;
ELSE IF the navigational user action of moving a scrollbar or selecting a timeline control icon is taken THEN
determining a new value for Current Timeline Time;
ELSE
returning to determining whether a navigational user action is taken.

13. An online collaboration system comprising:
a processor;
a conduct logic configured to conducting, by an online collaboration service executing on a computer system, an online collaboration session with one or more users;
a receipt logic configured to receiving, by the online collaboration service, streaming data from the one or more users;
a distribute logic configured to distributing, by the online collaboration service, the received streaming data to the one or more users;
a perform logic configured to performing, by the online collaboration service, one or more collaborative user actions;
a present logic configured to presenting, by the online collaboration service, an activity timeline;
a record logic configured to recording, by the online collaboration service, the distributed streaming data and the presented activity timeline;
a playback logic configured to playing back, by the online collaboration service, the recorded streaming data and the recorded activity timeline; and
a navigate logic configured to navigating, by the online collaboration service, the playing back of the recorded streaming data and the recorded activity timeline.

14. The system of claim 13, wherein the collaborative user actions include start session, end session and join session.

15. The system of claim 13, wherein the collaborative user actions include invite user.

16. The system of claim 13, wherein the collaborative user actions include post message.

17. The system of claim 13, wherein the collaborative user actions include start screen share and end screen share.

18. The system of claim 13, wherein the collaborative user actions include start file share and end file share.

19. The system of claim 13, wherein the collaborative user actions include start whiteboarding, participate in whiteboarding and end whiteboarding.

20. The system of claim 13, wherein the collaborative user actions include start remote device control, give access to remote device control and end remote device control.

21. A non-transitory, computer-readable medium storing program instructions that, when executed by a processor, cause the processor to perform the method of:
conducting, by an online collaboration service executing on a computer system, an online collaboration session with one or more users;
receiving, by the online collaboration service, streaming data from the one or more users;
distributing, by the online collaboration service, the received streaming data to the one or more users;
performing, by the online collaboration service, one or more collaborative user actions;
presenting, by the online collaboration service, an activity timeline;
recording, by the online collaboration service, the distributed streaming data and the presented activity timeline;
playing back, by the online collaboration service, the recorded streaming data and the recorded activity timeline; and
navigating, by the online collaboration service, the playing back of the recorded streaming data and the recorded activity timeline.

22. The medium of claim 21, wherein the collaborative user actions include start session, end session and join session.

23. The medium of claim 21, wherein the collaborative user actions include invite user.

24. The medium of claim 21, wherein the collaborative user actions include post message.

25. The medium of claim 21, wherein the collaborative user actions include start screen share and end screen share.

26. The medium of claim 21, wherein the collaborative user actions include start file share and end file share.

27. The medium of claim 21, wherein the collaborative user actions include start whiteboarding, participate in whiteboarding and end whiteboarding.

28. The medium of claim 21, wherein the collaborative user actions include start remote device control, give access to remote device control and end remote device control.
